(19) United States
(12) Patent Application Publication
(10) Pub. No.: US 2016/0070610 A1
(43) Pub. Date: Mar. 10, 2016

(54) SEMICONDUCTOR DEVICE

(71) Applicant: KABUSHIKI KAISHA TOSHIBA, Tokyo (JP)

(72) Inventor: Tatsuo MIZUTANI, Yokohama Kanagawa (JP)

(21) Appl. No.: 14/634,867

(22) Filed: Mar. 1, 2015

(30) Foreign Application Priority Data
Sep. 4, 2014 (JP) 2014-180055

(51) Int. Cl. G06F 11/07

(52) U.S. Cl. CPC G06F 11/076; G06F 11/0721; G06F 11/0784

(57) ABSTRACT

A semiconductor device includes a counter configured to increment a counter value each predetermined time period, a register storing values including a first value and a second value that is smaller than the first value, and a comparator configured to compare the counter value with the stored values, output a first signal to an external device if the counter value is greater than the first value when an initialization command is received from the external device, and set a flag in the register if the counter value is greater than the second value and smaller than the first value when the initialization command is received.

### CROSS-REFERENCE TO RELATED APPLICATION

This application is based upon and claims the benefit of priority from Japanese Patent Application No. 2014-180055, filed Sep. 4, 2014, the entire contents of which are incorporated herein by reference.

### FIELD

Embodiments described herein relate generally to a semiconductor device that transmits an error signal to an external device.

### BACKGROUND

A watchdog timer (WDT) is a circuit for determining whether or not processing of a CPU or the like is normally operating, based on a clearing signal from the CPU. The WDT determines that the CPU is normally operating when the clearing signal is periodically received from the CPU. When the clearing signal is not received for a predetermined period of time, the WDT generates a WDT error interrupt signal. When the WDT error interrupt signal is generated, the CPU performs system breakdown processing, for example.

The clearing signal is not transmitted for the predetermined period of time, for example, when the CPU malfunctions, or when transmission of the clearing signal is delayed because application processing is extended by multiple interrupt processing, although the CPU is normally operating.

When the CPU is normally operating, it is desirable that the WDT error interrupt signal be not generated.

### DESCRIPTION OF THE DRAWINGS

FIG. 1 is a block diagram of a micro control unit (MCU) according to a first embodiment.

FIG. 2 illustrates specification of a register in the MCU according to the first embodiment.

FIG. 3 is a timing diagram illustrating timing of clearing processing carried out by the MCU of FIG. 1.

FIG. 4 illustrates specification of a register in the MCU according to a second embodiment.

FIG. 5 illustrates specification of a register in the MCU according to a third embodiment.

FIG. 6 illustrates specification of a register in the MCU according to a fourth embodiment.

FIG. 7 illustrates specification of a register in the MCU according to a fifth embodiment.

### DETAILED DESCRIPTION

An exemplary embodiment provides a semiconductor device that reduces generation of an unnecessary WDT error interrupt.

In general, according to one embodiment, a semiconductor device includes a counter configured to increment a counter value each predetermined time period, a register storing values including a first value and a second value that is smaller than the first value, and a comparator configured to compare the counter value with the stored values, output a first signal to an external device if the counter value is greater than the first value when an initialization command is received from the external device, and set a flag in the register if the counter value is greater than the second value and smaller than the first value when the initialization command is received.

Hereinafter, exemplary embodiments will be described with reference to the drawings. The exemplary embodiments do not limit the invention.

### First Embodiment

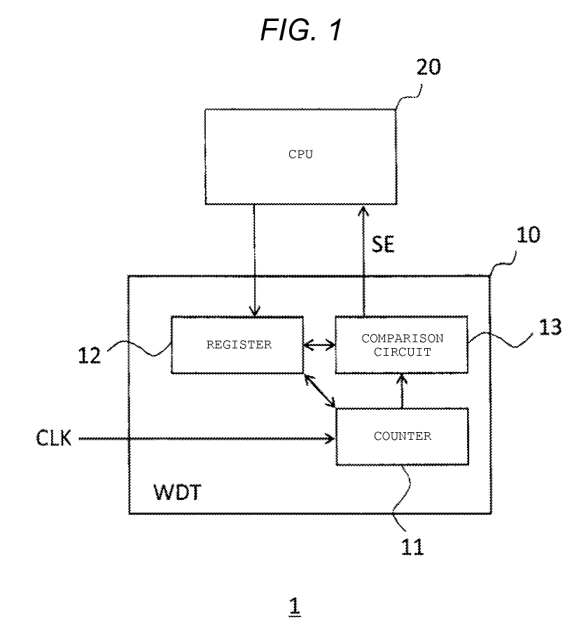

FIG. 1 is a block diagram of a micro control unit (MCU) 1 according to a first embodiment. The MCU 1 is configured as a semiconductor integrated circuit. The MCU 1 of FIG. 1 includes a WDT (diagnosis circuit) 10, and a CPU (computation circuit) 20. The WDT 10 includes a counter 11, a register 12, and a comparison circuit 13.

The counter 11 increments a counter value from an initial value, and the counter value may be cleared by a control of an external device. After the counter value is cleared, the counter 11 increments again the counter value from the initial value.

The register 12 stores control values for operating the WDT 10, in particular a counter maximum value, a warning flag setting maximum value smaller than the counter maximum value, a warning flag setting minimum value smaller than the warning flag setting maximum value, and a counter minimum value smaller than the warning flag setting minimum value.

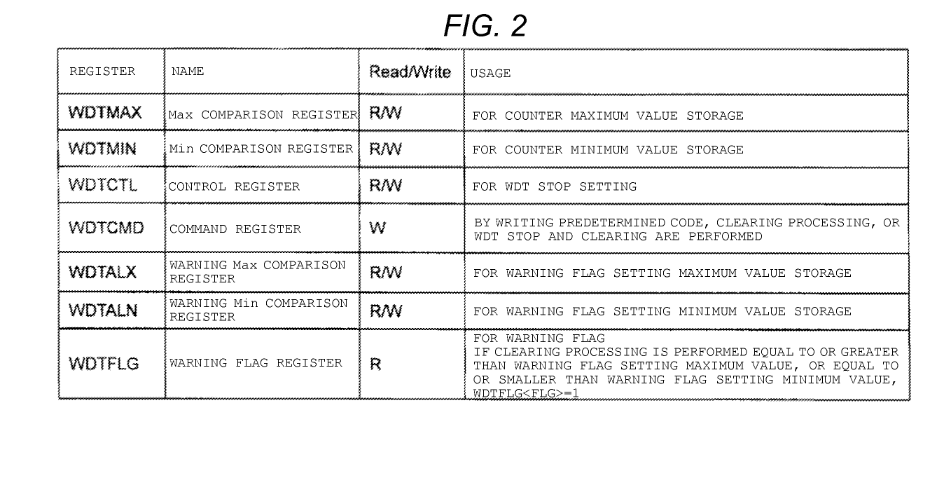

FIG. 2 illustrates specification of the register 12 according to the first embodiment. As illustrated in FIG. 2, the register 12 includes a plurality of registers WDTMAX, WDTMIN, WDTCTL, WDTCMD, WDTALX, WDTALN, and WDTFLG.

The register WDTMAX stores the counter maximum value. The register WDTMIN stores the counter minimum value. The register WDTCTL sets WDT stop. A predetermined code is written to the register WDTCMD. The register WDTALX stores the warning flag setting maximum value. The register WDTALN stores the warning flag setting minimum value. The register WDTFLG sets a warning flag.

The WDT 10 performs the clearing processing of the counter value, or the WDT stop and clearing of each register, according to the written code.

The comparison circuit 13 compares a counter value of the counter 11 with a value stored in the register 12. Specifically, when the counter value is equal to or greater than the counter maximum value, the comparison circuit 13 outputs an error interrupt signal SE to the CPU 20.

When the counter value at the time of being cleared is equal to or greater than the warning flag setting maximum value and is smaller than the counter maximum value, the comparison circuit 13 sets a warning flag in the register 12. When the register WDTFLG<FLG>=1, it represents that the warning flag is set, and when the register WDTFLG<FLG>=0, it represents that the warning flag is not set.

When the counter value at the time of being cleared is equal to or smaller than the counter minimum value, the comparison circuit 13 outputs the error interrupt signal SE to the CPU 20.

When the counter value at the time of being cleared is greater than the counter minimum value and is equal to or smaller than the warning flag setting minimum value, the comparison circuit 13 sets the warning flag in the register 12.

The CPU 20 performs computation and periodically clears (clearing processing) the counter value of the counter 11, based on an application program or the like. Specifically, the CPU 20 writes a predetermined code to the register WDTCMD, based on which the register 12 clears the counter value of the counter 11.

The WDT error interrupt is generated based on the error interrupt signal SE. When the error interrupt signal SE is supplied from the comparison circuit 13, the CPU 20 performs predetermined processing, such as a system breakdown.

In addition, if, by the CPU 20, a predetermined value is written to the register WDTCTL and a predetermined code is written to the register WDTCMD, the WDT 10 stops an operation and each register is cleared.

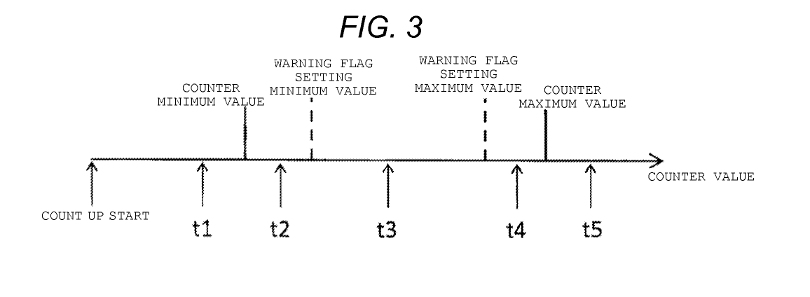

Next, an operation of the MCU 1 will be described with reference to FIG. 3.

FIG. 3 is a timing diagram illustrating timing of clearing processing of the MCU 1 according to the present embodiment. After the counter 11 starts to increment the counter value, if the clearing processing is performed when the counter value is equal to or smaller than the counter minimum value (t1), the comparison circuit 13 outputs the error interrupt signal SE. As an example of this case, the CPU 20 malfunctions and whereby the clearing processing is performed at abnormal timing.

In addition, if the clearing processing is performed when the counter value is greater than the counter minimum value and is equal to or smaller than the warning flag setting minimum value (t2), the comparison circuit 13 sets the warning flag in the register 12. In this case, the clearing processing is quickened more than that in normal timing. For this reason, if the CPU 20 continues the processing as it is, there is a high possibility that the clearing processing is further quickened and the error interrupt signal SE is output.

In addition, if the clearing processing is performed when the counter value is greater than the warning flag setting minimum value and is smaller than the warning flag setting maximum value (t3), the MCU 1 enters a normal state.

In addition, if the clearing processing is performed when the counter value is equal to or greater than the warning flag setting maximum value and is smaller than the counter maximum value (t4), the comparison circuit 13 sets the warning flag in the register 12. In this case, the clearing processing is delayed more than that at normal timing. For this reason, if the CPU 20 continues the processing as it is, there is a high possibility that the clearing processing is further delayed and the error interrupt signal SE is output.

In addition, if the clearing processing is performed when the counter value is equal to or greater than the counter maximum value (t5), that is, if the clearing processing is not performed even when the counter value is equal to the counter maximum value, the comparison circuit 13 outputs the error interrupt signal SE when the counter value becomes the counter maximum value.

The CPU 20 periodically checks whether or not the warning flag is set in the register 12. When the warning flag is detected, the CPU 20 can recognize that the clearing processing is quickened or delayed with respect to the normal timing. The CPU 20 determines whether clearing processing is quickened or delayed, based on various information items.

When the warning flag is detected, the CPU 20 adjusts a load, thereby adjusting the timing of subsequent clearing processing. When the clearing processing is delayed, the CPU 20 stops a portion of an application program, a program for diagnosis, or the like which is being executed, thereby simplifying the processing and reducing a load. The program for diagnosis diagnoses a function of the MCU 1, unlike the application program.

As a result, before the clearing processing is so delayed that the WDT error interrupt is generated, it is possible to quicken the clearing processing. Thus, it is possible to reduce generation of an unnecessary WDT error interrupt simply due to the fact that the processing of the CPU 20 delayed while the CPU 20 performs a normal operation.

Meanwhile, when the clearing process is quick, the CPU 20 newly executes an application program, a program for diagnosis, or the like, thereby increasing a load. As a result, before the clearing processing is quickened due to the generation of the WDT error interrupt, it is possible to delay the clearing processing. For example, when the clearing processing is delayed, the program for diagnosis, or the like is stopped. If the application processing is ended, the load may be excessively reduced and the clearing processing may be excessively quickened. In the present embodiment, even to this case, an appropriate action is taken by adjusting the load. Thus, it is possible to reduce generation of an unnecessary WDT error interrupt simply due to the fact that the load of the CPU 20 is excessively reduced while the CPU 20 performs a normal operation.

Alternatively, for example, when stopping the program for diagnosis is not desirable from viewpoint of a functional safety, when an application program or a program for diagnosing which may be stopped does not exist, or the like, the CPU 20 may update the counter maximum value of the register 12 to a greater value, and may delay the timing in which the WDT error interrupt is generated, when the warning flag is detected. As a result, it is possible to reduce generation of an unnecessary WDT error interrupt.

Here, the WDT of a comparative example will be described. In the WDT of the comparative example, the counter maximum value is set to a great value in advance so as not to generate the WDT error interrupt when the CPU performs a normal operation but the application processing is extended whereby the clearing processing is delayed. The counter maximum value is set based on a maximum delay of the clear processing. For this reason, even when, actually, the CPU malfunctions whereby the clear processing is not performed, the generation of the WDT error interrupt is delayed, and processing or system breakdown or the like is delayed. Thus, since a state where the malfunction of the CPU continues for a longer period of time, it is not desirable.

In contrast, in the present embodiment, the counter maximum value may not be great, and in addition, even when the counter maximum value is great, it is possible to set the counter maximum value to a value smaller than that of the comparative example. For this reason, it is possible to generate the WDT error interrupt quicker than that of the comparative example.

According to the present embodiment, when the counter value at the time of being cleared is greater than the warning flag setting maximum value and is smaller than the counter maximum value, and when the counter value at the time of being cleared is greater than the counter minimum value and is equal to or smaller than the warning flag setting minimum value, the warning flag is set. As a result, when the warning flag is detected, it is possible for the CPU 20 to adjust a load in such a manner that the clearing processing may be performed in a more appropriate timing. Thus, it is possible to reduce generation of an unnecessary WDT error interrupt due to the fact that the processing of the CPU 20 is delayed or the load of the CPU 20 is excessively reduced.

In addition, the most part of the unnecessary WDT error interrupt is generated due to a delay of the processing of the CPU 20. For this reason, when the MCU 1 is inexpensively configured, an action may not be able to be taken to the load of the CPU 20 that is excessively reduced. That is, when the counter value at the time of being cleared is greater than the counter minimum value and is equal to or smaller than the warning flag setting minimum value, the comparison circuit 13 may not set the warning flag. In this case, it is possible to reduce the generation of an unnecessary WDT error interrupt due to a delay of the processing of the CPU 20. In addition, it is possible to simplify the configuration and processing of the MCU 1.

### Second Embodiment

In a second embodiment, a warning flag is changed according to the cleared timing. Hereinafter, a different point from the first embodiment will be mainly described.

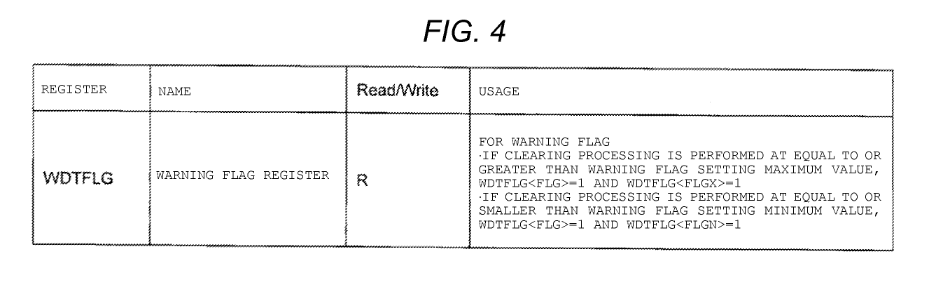

FIG. 4 illustrates specification of a register 12 according to the second embodiment. A function of the register WDTFLG is different from that of the first embodiment.

When the counter value at the time of being cleared is equal to or greater than the warning flag setting maximum value, the comparison circuit 13 sets the maximum warning flag in the register 12, as a warning flag. When the register WDTFLG<FLGX>=1, it represents that the maximum warning flag is set, and when the register WDTFLG<FLGX>=0, it represents that the maximum warning flag is not set.

When the counter value at the time of being cleared is greater than the counter minimum value and is equal to or smaller than the warning flag setting minimum value, the comparison circuit 13 sets the minimum warning flag in the register 12, as a warning flag. When the register WDTFLG<FLGN>=1, it represents that the minimum warning flag is set, and when the register WDTFLG<FLGN>=0, it represents that the minimum warning flag is not set. In addition, the register WDTFLG<FLG> that represents the warning flag may be used and may not be used.

As a result, depending on whether the maximum warning flag is set or the minimum warning flag is set, the CPU 20 may determine whether the clearing processing is quickened or delayed, more easily than the first embodiment. Thus, it is possible to simplify the processing of the CPU 20 more than that of the first embodiment.

### Third Embodiment

In a third embodiment, when the clearing processing is performed in normal timing, a warning flag is cleared. Hereinafter, a different point from the first embodiment will be mainly described.

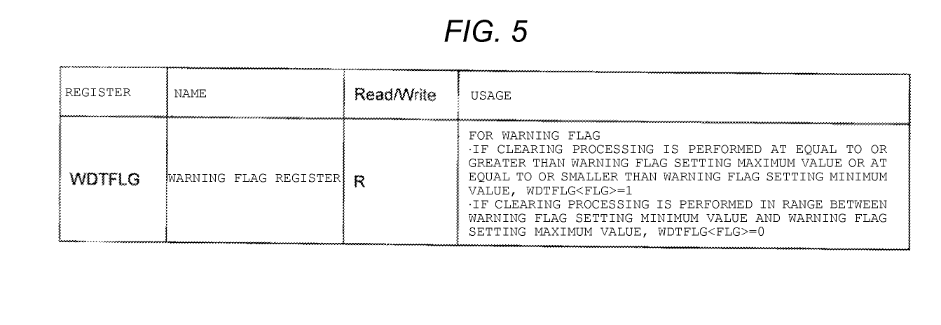

FIG. 5 illustrates a register 12 according to the third embodiment. A function of the register WDTFLG is different from that of the first embodiment.

When the counter value at the time of being cleared is greater than the warning flag setting minimum value and is smaller than the warning flag setting maximum value, the comparison circuit 13 clears a warning flag. That is, the comparison circuit 13 sets the register WDTFLG<FLG>=0.

As a result, when the cleared warning flag is detected after detecting the warning flag, the CPU 20 may recognize that the load is appropriately adjusted. Thus, when the load is reduced, the CPU 20 may execute the program for diagnosis or the like again.

In addition, the third embodiment may be combined with the second embodiment.

### Fourth Embodiment

In a fourth embodiment, a different point from the first embodiment that may disable a warning flag function will be mainly described.

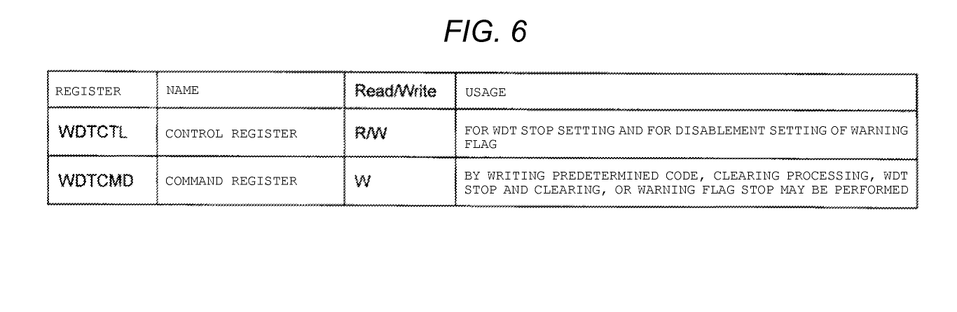

FIG. 6 illustrates a register 12 according to the fourth embodiment. Functions of the register WDTCTL and WDTCMD are different from those of the first embodiment. The register WDTCTL sets stop of the WDT and disablement of the warning flag. A predetermined code that disables the warning flag function is written to the register WDTCMD, in addition to the function of the first embodiment.

When a disabling signal from the CPU 20 is set, that is, when the register is set to one (WDTCTL<FLGDIS>=1), and a predetermined code is written to the register WDTCMD, the comparison circuit 13 disables the warning flag function. In this case, the comparison circuit 13 does not set the warning flag regardless of a comparison result. When the warning flag function is enabled again, the register may be set to zero (WDTCTL<FLGDIS>=0), for example.

It may be desirable that the warning flag be not set depending on an application program executed by the CPU 20. In the present embodiment, an appropriate action may be taken even to this case.

In addition, the fourth embodiment may be combined with at least one of the second and third embodiments.

### Fifth Embodiment

In a fifth embodiment, a warning flag interrupt signal is output. Hereinafter, a different point from the first embodiment will be mainly described.

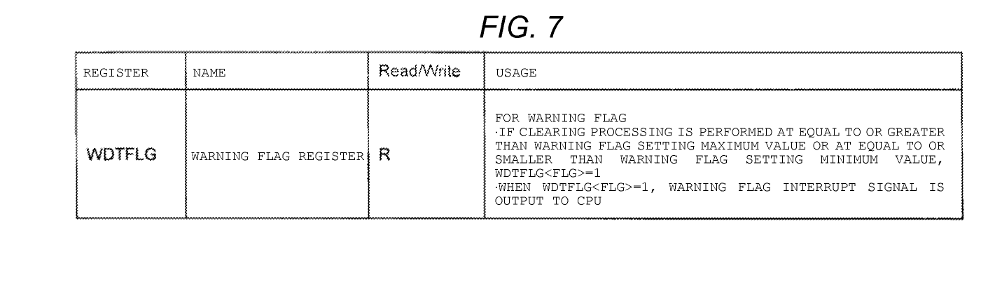

FIG. 7 illustrates a register 12 according to the fifth embodiment. If the register is set to one (WDTFLG<FLG>=1), the warning flag interrupt signal is output to the CPU 20. That is, when the clearing process is performed, the comparison circuit 13 sets the warning flag in the register 12 and outputs the warning flag interrupt signal to the CPU 20.

Even without checking periodically whether or not the warning flag is set, the CPU 20 may detect easily and quickly that the warning flag is set using the warning flag interrupt signal. Thus, the CPU 20 may perform appropriate processing in quicker timing than that of the first embodiment.

In addition, the fifth embodiment may be combined with at least one of the second to fourth embodiments.

At least a portion of the WDT 10 described in the above-described embodiments may be configured with hardware and may be configured with software. When being configured with software, a program that achieves a function of at least a portion of the WDT 10 may be recorded in a recording medium such as a flexible disc or a CD-ROM, and may be read by a computer to be executed. The recording medium is not limited to a detachable and attachable device such as a magnetic disc or an optical disc, and may be a fixed recording medium such as a hard disc device or a memory.

In addition, a program that achieves a function of at least a portion of the WDT 10 may be distributed via a communication line (including wireless communication) such as the Internet. Furthermore, in a state of being encoded or modulated and then compressed, the program may be distributed via a wired line or a wireless line such as the Internet, or a recording medium in which the program is stored.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A semiconductor device comprising:
a counter configured to increment a counter value each predetermined time period;
a register storing values including a first value and a second value that is smaller than the first value; and
a comparator configured to compare the counter value with the stored values, output a first signal to an external device if the counter value is greater than the first value when an initialization command is received from the external device, and set a flag in the register if the counter value is greater than the second value and smaller than the first value when the initialization command is received.

2. The semiconductor device according to claim 1, wherein
the stored values further includes a third value that is smaller than the second value, and a fourth value that is smaller than the third value, and
the comparator is further configured to output a second signal to the external device if the counter value is smaller than the fourth value when the initialization command is received, and set a flag in the register if the counter value is greater than the fourth value and smaller than the third value when the initialization command is received.

3. The semiconductor device according to claim 2, wherein
the same flag is set in the register when the counter value is greater than the second value and smaller than the first value and when the counter value is greater than the fourth value and smaller than the third value.

4. The semiconductor device according to claim 2, wherein
different flags are set in the register when the counter value is greater than the second value and smaller than the first value and when the counter value is greater than the fourth value and smaller than the third value.

5. The semiconductor device according to claim 1, wherein
the first signal causes the external device to carry out system down processing.

6. The semiconductor device according to claim 1, wherein
the comparator is configured to transmit an interrupt signal to the external device if the flag is set in the register.

7. The semiconductor device according to claim 1, wherein
the flag is read by the external device and, when set, the flag causes the external device to change an interval of transmitting the initialization command.

8. The semiconductor device according to claim 1, wherein
the comparator is further configured to clear the flag set in the register if the counter value is greater than the third value and smaller than the second value when the initialization command is received.

9. The semiconductor device according to claim 1, wherein
the comparator is further configured to receive a disabling command from the external device, and not set the flag in the register when the disabling command is received even if the counter value is equal to or greater than the second value and smaller than the first value.

10. The semiconductor device according to claim 1, wherein
the external device is a processor.

11. A semiconductor device comprising:
a processor configured to transmit an initialization command;
a counter configured to increment the counter value each predetermined time period;
a register storing values including a first value and a second value that is smaller than the first value; and
a comparator configured to compare the counter value with the stored values, output a first signal to the processor if the counter value is greater than the first value when the initialization command is received from the processor, and set a flag in the register if the counter value is greater than the second value and smaller than the first value when the initialization command is received.

12. The semiconductor device according to claim 11, wherein
the stored values further includes a third value that is smaller than the second value, and a fourth value that is smaller than the third value, and
the comparator is further configured to output a second signal to the processor if the counter value is smaller than the fourth value when the initialization command is received, and set a flag in the register if the counter value is greater than the fourth value and smaller than the third value when the initialization command is received.

13. The semiconductor device according to claim 12, wherein
the same flag is set in the register when the counter value is greater than the second value and smaller than the first value and when the counter value is greater than the fourth value and smaller than the third value.

14. The semiconductor device according to claim 12, wherein
different flags are set in the register when the counter value is greater than the second value and smaller than the first value and when the counter value is greater than the fourth value and smaller than the third value.

15. The semiconductor device according to claim 11, wherein
the comparator is further configured to clear the flag set in the register if the counter value is greater than the third value and smaller than the second value when the initialization command is received.

16. A method for operating a semiconductor device, comprising:
counting up a counter value each predetermined time period;
receiving an initialization command;
storing values including a first value and a second value that is smaller than the first value;
comparing the counter value with one or more of the stored values;
outputting a first signal to an external device if the counter value is greater than the first value when the initialization command is received; and
setting a flag in a register if the counter value is greater than the second value and smaller than the first value when the initialization command is received.

17. The method according to claim 16, wherein the stored values further includes a third value that is smaller than the second value, and a fourth value that is smaller than the third value, the method further comprising:
outputting a second signal to the external device if the counter value is smaller than the fourth value when the initialization command is received; and
setting a flag in the register if the counter value is greater than the fourth value and smaller than the third value when the initialization command is received.

18. The method according to claim 16, wherein
the same flag is set in the register when the counter value is greater than the second value and smaller than the first value and when the counter value is greater than the fourth value and smaller than the third value.

19. The method according to claim 16, wherein
different flags are set in the register when the counter value is greater than the second value and smaller than the first value and when the counter value is greater than the fourth value and smaller than the third value.

20. The method according to claim 16, further comprising:
clearing the flag set in the register if the counter value is greater than the third value and smaller than the second value when the initialization command is received.
